(19) United States
(12) Patent Application Publication
(10) Pub. No.: US 2023/0157203 A1
(43) Pub. Date: May 25, 2023

(54) METHOD FOR CONTROLLING A ROBOTIC LAWNMOWER BY PROCESSING VIBRATIONS

(71) Applicant: VOLTA ROBOTS S.r.l., Milano (IT)

(72) Inventor: Silvio REVELLI, Milano (IT)

(73) Assignee: VOLTA ROBOTS S.r.l., Milano (IT)

(21) Appl. No.: 17/919,129

(22) PCT Filed: Apr. 12, 2021
(86) PCT No.: PCT/IB2021/053000

§ 371 Date: Oct. 14, 2022

(30) Foreign Application Priority Data
Apr. 14, 2020 (IT) 102020000007852

(51) Int. Cl. A01D 34/00; G05D 1/02

(52) U.S. Cl. CPC A01D 34/008; G05D 1/0255; A01D 2101/00

(57) ABSTRACT

A method controls a robotic lawnmower in a working environment. The robotic lawnmower includes a locomotion member, a grass cutting member, and vibration sensors for detecting mechanical vibrations generated in the working environment. The method includes detecting a mechanical vibration to generate an electrical signal representative of the mechanical vibration. An electronic processing unit processes the generated electrical signal to extract a feature of the signal to generate a vibrometric mark of the signal. The generated vibrometric mark is classified to obtain a class identifier associated with the vibrometric mark. The identifier may have a first value indicating a desirable activity performed by the robotic lawnmower or a second value indicating an undesirable activity. A control signal is generated to control the locomotion member or the grass cutting member when the class identifier has the second value to bring the robotic lawnmower back to a condition of desirable activity.

### TECHNOLOGICAL BACKGROUND OF THE INVENTION

### Field of Application

The present invention generally relates to the field of controlling robotic lawnmowers, for example lawnmowers or robotic lawnmowers, configured to operate autonomously or semi-autonomously.

In particular, the invention relates to a method for automatically identifying an undesired activity performed by the robotic lawnmower and to control the lawnmower accordingly, confining it to a grassy area. In particular, the invention discloses a method for detecting an undesired activity by processing mechanical vibrations generated in said working environment and which are propagated through a body of the robotic lawnmower or through the surrounding air and are detected by means of vibration sensors.

The invention also relates to a system which includes the robotic lawnmower configured to implement the aforesaid method.

### Prior Art

Lawnmower machinery or robotic lawnmowers configured to operate in autonomous manner, i.e. without the guide of an operator, are currently available on the market for residential use. Such robotic lawnmowers are configured to operate in a working area considered to be safe.

Under operating or standard working conditions, the lawnmower moves in a grassy working area in which at least one rotating blade of the lawnmower itself usually is in contact with the grass to be cut.

During the course of the work performed by the robotic lawnmower, an undesirable or unsafe activity occurs when the robotic lawnmower is in an area with no turf (for example, on a sidewalk or road), or in a situation in which an object other than grass (for example, a root of a plant, the corner of a stone, etc.) comes into contact with the blade.

Currently, to avoid such undesirable events from occurring, use is made of a step of preparing the working area by laying an electrically-powered perimeter cable which may be recognized by the robotic lawnmower through a respective sensor. Such a perimeter cable delimits the grassy area in which the lawnmower may work in addition to being shaped around blower beds and bushes and excluding areas with stones and roots.

However, delimiting the working area by laying the perimeter cable is often an excessively lengthy and laborious activity for the user. Moreover, as the yard is a highly dynamic and continuously evolving environment, the activity of laying the perimeter cable often requires to be repeated with the succession of the seasons in order to take into consideration the changes occurred in the working area.

Additionally, even after the correct delimitation of the working area with the perimeter cord, the robotic lawnmower blade accidentally coming into contact with objects which could be damaged by the blade itself or which could damage it, cannot be excluded.

In order to mitigate these drawbacks at least partially, the robotic lawnmowers currently on the market are configured to monitor the rotation speed of the blade and the current absorbed by the motor moving it to detect possible reductions in the rotation speed of the blade or efforts in the cutting action representative of a possible contact of the blade with a foreign object. However, since a regular cutting of the grass may significantly alter the rotation speed of the blade and the cutting effort, such a known method is not very reliable in discriminating a standard working condition from an undesirable or unsafe activity.

Moreover, it is not possible to exclude that the lawnmower may get caught up in the bushes which may have grown past the delimiting cable during the growing season.

### SUMMARY OF THE INVENTION

It is the object of the present invention to devise and provide a method and related system for identifying an undesirable activity performed by a robotic lawnmower and for controlling the robotic lawnmower during a movement in working environment so as to at least partially overcome the drawbacks mentioned above in relation to the known methods.

Such an object is achieved by a method for controlling a robotic lawnmower according to claim 1.

In particular, the method of the invention allows an undesirable or unsafe activity performed by the robotic lawnmower to be automatically detected and identified and the motion of the lawnmower to be controlled by confining it to a grassy area, thus minimizing the contact time between the blade and objects other than the grass.

In particular, the invention discloses a method for detecting the aforesaid undesirable activity by processing mechanical vibrations generated in the working environment and which are propagated through a body of the robotic lawnmower or through the surrounding air and are detected by means of one or more vibration sensors.

The terms “vibration”, “sound” or “mechanical wave” may be used in an interchangeable manner in the present description. It should be noted that a “sound” is a mechanical wave propagated into the air. Sounds may be generated by “vibrations” of rigid bodies.

Preferred embodiments of such a control method are described in the dependent claims.

The invention also relates to a system according to claim 14, which includes the robotic lawnmower configured to implement the aforesaid method.

### BRIEF DESCRIPTION OF THE DRAWINGS

Further features and advantages of the method for controlling a robotic lawnmower and of the related system according to the invention will become apparent from the following description of preferred embodiments, given by way of indicative, non-limiting examples, with reference to the accompanying drawings, in which:

FIG. 1 shows, with a flow chart, a general example of a method for identifying an undesirable activity performed by a robotic lawnmower and for controlling the robotic lawnmower during a movement in working environment;

FIGS. 2A-2B diagrammatically show a system which includes a robotic lawnmower which is movable in a working environment which implements the method in FIG. 1;

FIG. 3 shows, with a flow chart, a first embodiment of the method for controlling the robotic lawnmower of the present invention;

FIG. 4 shows, with a flow chart, a second embodiment of the method for controlling the robotic lawnmower of the present invention;

FIG. 5 shows, with a flow chart, a third embodiment of the method for controlling the robotic lawnmower of the present invention;

FIG. 6 shows, with a flow chart, a fourth embodiment of the method for controlling the robotic lawnmower of the present invention;

FIGS. 7A-7B show, diagrammatically and with a flow chart, a fifth embodiment of the method for controlling the robotic lawnmower of the present invention;

FIG. 8 shows, with a flow chart, a sixth embodiment of the method for controlling the robotic lawnmower of the present invention;

FIGS. 9A-9B-9C show, as a function of time, trends of a vibration signal detected by means of accelerometer associated with the robotic lawnmower in

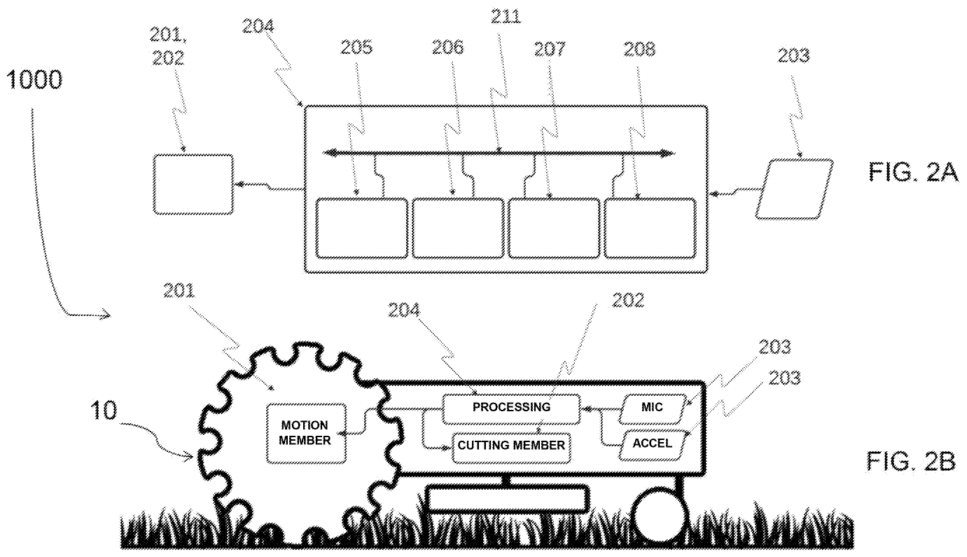

FIG. 2B when the robotic lawnmower operates on turf, asphalt, or turf and the blades periodically came into contact with objects other than grass, respectively;

FIGS. 10A-10H diagrammatically show examples of activities which may be performed by the robotic lawnmower in FIGS. 2A-2B and the sources of vibrations which may be associated with each of them;

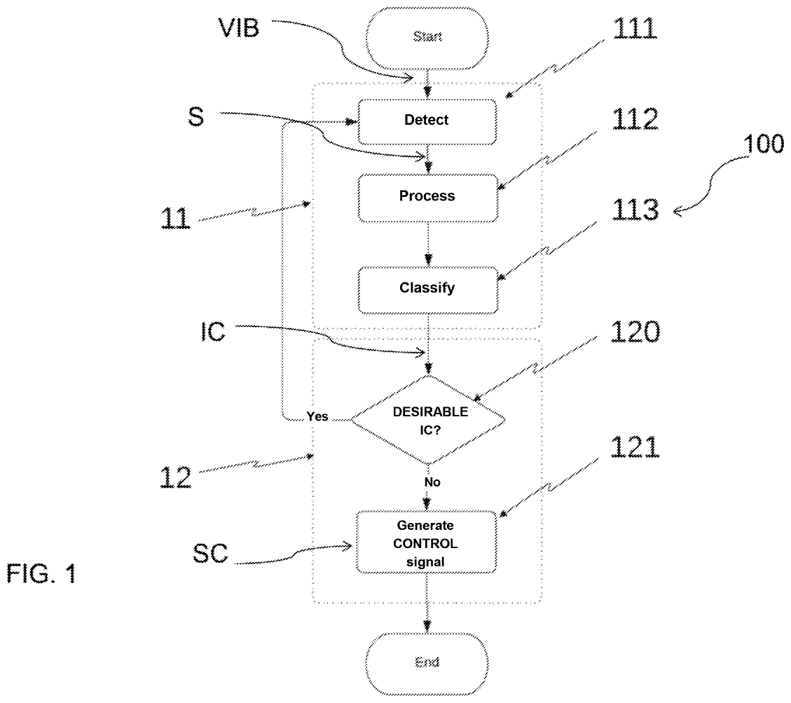

FIG. 11 shows an embodiment of a classification step of the method in FIG. 1 obtained employing a decision tree;

FIG. 12 shows an embodiment of a classification step of the method in FIG. 1 employing a spectrogram and a trained neural network.

In the aforesaid figures, equal or similar elements will be indicated with the same reference numerals.

### DETAILED DESCRIPTION

With reference to FIG. 1, a method for identifying an undesirable activity performed by a robotic lawnmower 10 and for controlling the robotic lawnmower during a movement in a working environment according to the present invention, is indicated by numeral 100.

In general, when the robotic lawnmower 10 leaves the turf and starts moving on another surface, the vibrating method of the lawnmower itself changes, since the at least one locomotion member of the lawnmower, in contact with the ground, behaves in a different manner.

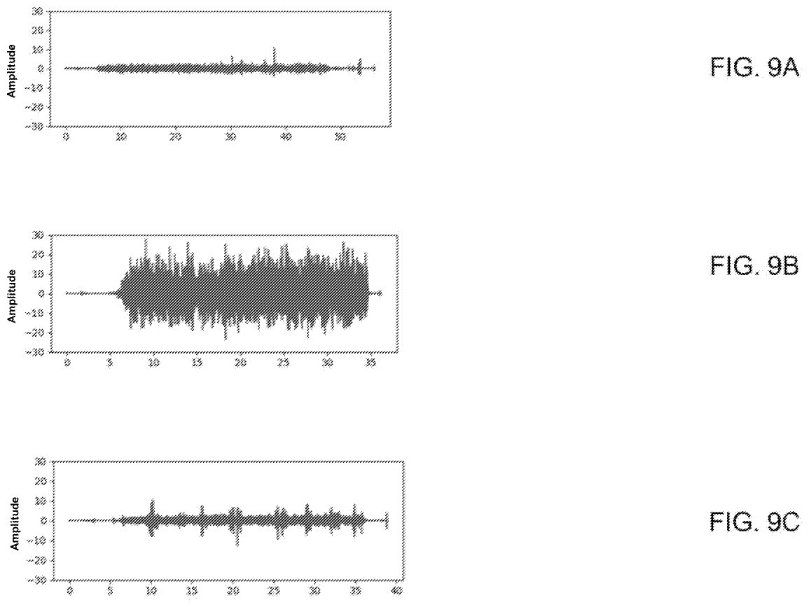

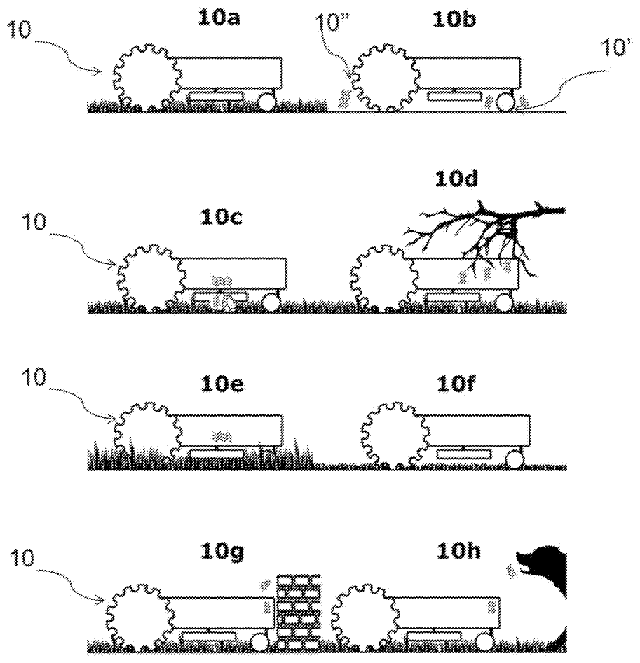

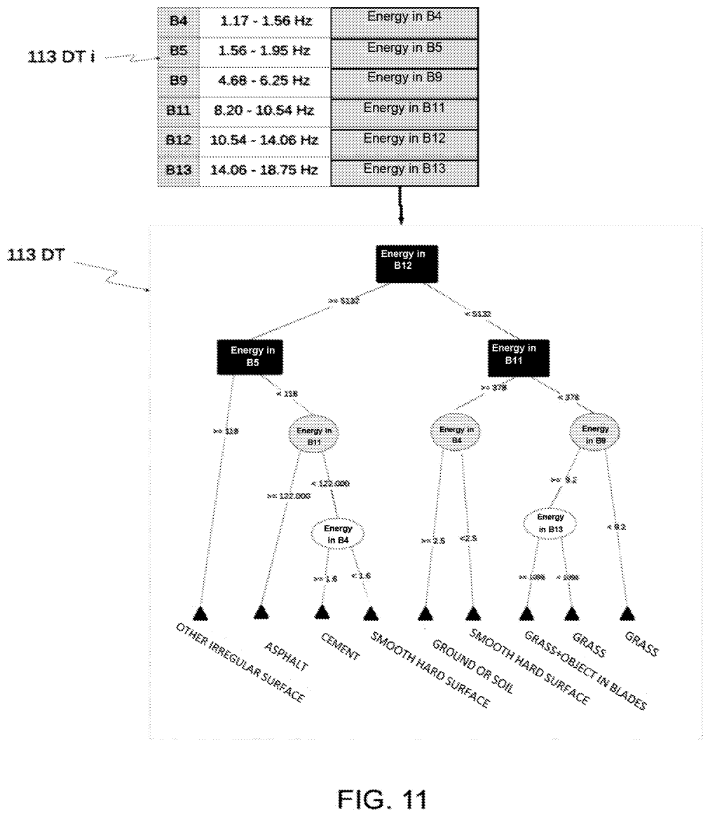

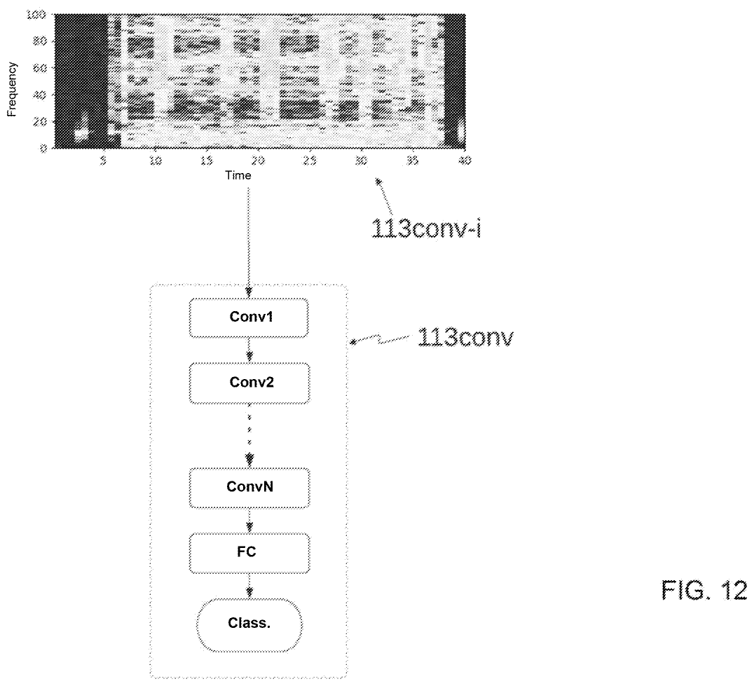

Moreover, when a robotic lawnmower 10 leaves the turf, also the cutting member, i.e. the blade, which on the turf was conventionally in contact with the tip of the grass blades, does not emit vibrations on the typical cutting frequency because it cannot be in contact with anything. Such different vibrating methods substantially uniquely characterize the operating working conditions of the robotic lawnmower 10 on the turf and off the turf, as shown by the trends of the signals as a function of time in FIGS. 9A, 9B.

In particular, FIG. 9A depicts a vibration signal detected by means of accelerometer associated with the robotic lawnmower 10, in the bands 0-100 Hz when the robotic lawnmower operates on grass.

FIG. 9B depicts a vibration signal detected by means of accelerometer in the bands 0-100 Hz when the robotic lawnmower 10 operates on asphalt (time interval from second 6 to second 34).

FIG. 9C depicts a vibration signal detected by means of accelerometer in the bands 0-100 Hz when the robotic lawnmower 10 operates on grass if the blades came into contact with objects other than grass in the time intervals (in seconds): 10-11, 16-17, 20-21, 25-27, 29-30, 32-33 and 35.

In other words, when an object other than grass comes into contact with the blades during regular operability, the typical noise associated with the robotic lawnmower is altered. For example, starting with the signal in FIG. 9C, an increase of the energy in all the frequency bands and a corresponding increase in energy in the frequency bands greater than 60 Hz and in the band 3.000-6.000 Hz, may be recorded. Such increases in the band 3.000-6.000Hz may be detected, for example by means of a microphone located in the part below the lawnmower.

The aforesaid unsafe activity conditions are easily identified also by an operator who is listening, since the vibrations generated by the activity of the lawnmower are also propagated through aerial means.

In addition to leaving the turf and the contact of the blade with objects, the mechanical waves also uniquely characterize other conditions of undesirable activity, among which for example: rubbing of the box-like body of the robotic lawnmower against objects, idling wheels, grass which is too long, impacts of the robotic lawnmower against rigid surfaces, other non-standard vibrations. Human voices and sounds of pets which are propagated as mechanical aerial waves may also be recognized through a microphone.

As described later, according to the present invention, each of the aforesaid conditions of undesirable or unsafe activity may be associated with a typical, detectable, and classifiable vibrometric mark, starting from which a specific corrective action may be undertaken.

With reference to FIGS. 2A-2B, a system comprising the aforesaid robotic lawnmower 10 is indicated as a whole by numeral 1000.

Such a robotic lawnmower 10 of system 1000 includes a suitable locomotion member 201 or motion member, and a grass cutting member 202.

The above-mentioned locomotion member 201 includes, by way of example, a propulsion unit powered by a respective energy source, a (also differential) steering unit, a stability and safety control unit and a power supply unit (e.g. a battery). Moreover, such a locomotion member 201 may also include suitable input/output communication interfaces for receiving command signals and returning signals indicating the movement.

The grass cutting member 202 includes one or more blades, e.g. circular blades, which are movable through a respective motor, and further input/output communication interfaces for receiving command signals and returning signals indicating the work performed.

Moreover, system 1000 comprises one or more vibration sensors 203 adapted to acquire at least one mechanical vibration generated in said working environment and which is propagated through the body of the robotic lawnmower or through the surrounding air.

Such vibration sensors materialize, for example in one or more microphones (MIC) and/or accelerometers (ACCEL) and/or gyroscopes.

Such vibration sensors 203 are, for example MEMS (Micro ElectroMechanical Systems) sensors, such as for example the accelerometer and gyroscope “LSM6DSOX” by ST Microelectronics, or the microphone “VM1000” by Vesper Technologies.

System 1000 further comprises an electronic processing unit 204 connected to the vibration acquisition means 203 and to the above-mentioned locomotion member 201 and grass cutting member 202.

In greater detail, the electronic processing unit 204 comprises at least one processor 205 and a memory block 206, 207 associated with the processor to store instructions. In particular, such a memory block 206, 207 is connected to processor 205 through a data line or communication bus 211 (e.g. PCI) and consists of a service memory 206 of the volatile type (e.g. of SDRAM type), and of a system memory 207 of non-volatile type (e.g. of SSD or eMMC type).

In greater detail, such an electronic processing unit 204 comprises input/output interface means 208 connected to the at least one processor 205 and to the memory block 206, 207 through the communication bus 211 to allow an operator close to system 1000 to directly interact with the processing unit itself.

Moreover, the electronic processing unit 204 is associated with a data communication interface of the wired or wireless type, not shown in FIG. 2A, configured to connect such a processing unit 204 to a data communication network, e.g. the Internet, to allow an operator to remotely interact with the processing unit 204 or to receive updates.

With reference to FIG. 1, the operating steps of the method 100 for controlling a robotic lawnmower on the basis of processing vibrations implemented through system 1000 are described below in greater detail.

In one embodiment, the electronic processing unit 204 of system 1000 is prepared to execute the codes of an application program which implements method 100 of the present invention.

In a particular embodiment, processor 205 is configured to upload, in the memory block 206, 207, and execute the codes of an application program which implements method 100 of the present invention.

It should be noted that during the operability of the lawnmower, the vibrations are constantly detected, processed, and classified to arrive at a prediction of the current activity 11 performed by the robotic lawnmower 10. Then control signals are sent 12 to the locomotion member 201 or the grass cutting member 202 according to such a prediction of activity. As disclosed in the following details, the steps 11 and 12 of the method are highly interconnected to each other and interdependent, thus making the invention unitary and specific to the context of application.

The method in FIG. 1 starts with a symbolic “Start” step and concludes with a symbolic “End” step.

In the more general embodiment, the control method 100 comprises a first step 111 of detecting at least one mechanical vibration VIB through the aforesaid one or more vibration sensors 203 to generate at least one electrical signal S representative of the at least one mechanical vibration.

According to a preferred embodiment, signal S is a digital signal; the vibration sensor 203 initially translates the mechanical vibrations into an analog electrical signal proportional thereto. Such a signal is acquired and digitalized with a time resolution given by the sampling period of the analog signal and a resolution in amplitude given by the number of bits with which each sampling is coded.

Then method 100 comprises a processing step 112, by means of an electronic processing unit 204, of the at least one generated electrical signal S to extract at least one feature of said signal S in order to generate a vibrometric mark of the signal.

In other words, the digital signal S is processed to extract one or more features of the signal in a reduced time interval which includes a plurality of samplings. Therefore, a vibrometric mark, i.e. a concise summary, generated in deterministic manner, of certain features of the vibration which may then be used to classify the vibration itself is obtained at the end of the processing step 112.

The processing techniques of an acoustic signal may, for example include assessing the energy of the signal in a given band, the “zero crossing rate”, extracting main tones, filtering one or more bands, calculating the Wiener entropy. A technique commonly used for processing the acoustic signal is the calculation of the spectrogram which can be obtained by means of Fast Fourier Transform (FFT), which visually represents how both the frequency and the amplitude (intensity) of such a signal varies over time. The selection of one or more bands may be performed by means of a bandpass filter in step 112.

Moreover, method 100 comprises a classification step 113 of such a generated vibrometric mark to obtain a class identifier IC associated with the vibrometric mark. Such a class identifier may take a first value indicating a desirable activity performed by the robotic lawnmower 10 or a second value indicating an undesirable or unsafe activity.

For example, a classification method which can be employed in method 100 provides comparing the energy of the signal in a given frequency band with a threshold value; in other words, two separate activities are discriminated by at least one threshold.

Various thresholds may also be sequentially used, on different bands, to distinguish in detail various different activities , thus forming decision trees. The discriminating conditions at the nodes of the decision trees may be manually set or learned by a processor by means of suitable “machine learning” techniques.

Other more complex classifiers, e.g. neural networks, may again be trained with “machine learning” techniques. In a preferred embodiment, a convolutional neural network (CNN) having a time portion of spectrogram as input layer and configured to perform convolutions thereon may be employed. In particular, the Applicant has verified that the DS-CNN neural networks (Depthwise Separable Convolutional Neural Network), which are known to those skilled in the art, are particularly effective for the purpose of accurately distinguishing the various activities, in a robust manner with respect to external disturbances and background noises. Alternatively, the employment of recurrent neural networks (RNN) as classifier of the time signal may be just as robust in a wide variety of working environments.

Method 100 of the invention provides a step 121 of generating at least one control signal SC of the locomotion member 201 or of the grass cutting member 202 when the aforesaid class identifier IC takes the second value, i.e. an undesirable activity, to bring the robotic lawnmower 10 back to a condition of desirable activity.

In other words, the output of the classification step 113 constitutes the prediction of the activity corresponding to the detected vibrations, thus distinguishing at least two activity classes 120. In the simplest embodiment, the two classes are desirable activity and undesirable activity. More sophisticated embodiments also allow to distinguish several types of undesirable activity, thus allowing a more specific control of the detected activity.

If the predicted activity is an undesirable activity, according to the example in FIG. 1, the method provides sending at least one corrective instruction 121 to the locomotion member 201 or the grass cutting member 202.

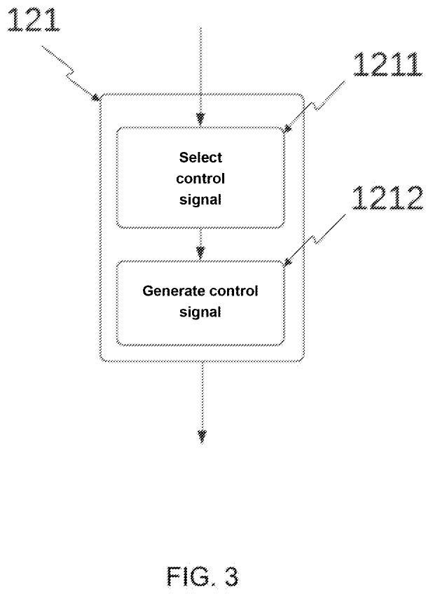

With reference to the embodiment in FIG. 3, the second value of the class identifier IC may include a plurality of second values, each indicating an undesirable activity and associated with one of a plurality of control signal sequences. In this case, method 100 provides for step 121 of generating a control signal for the robotic lawnmower 10 to comprises the steps of:
selecting 1211 a control signal sequence among the control signal sequences of such a plurality;
providing 1212 the locomotion member 201 or the grass cutting member 202 with the selected control signal sequence to bring the robotic lawnmower 10 back to a condition of desirable activity.

The prediction of the step 11 of method 100 may not be sufficiently accurate, for example due to external interferences, for example vibrations generated by machines operating close to the robotic lawnmower 10.

In this case, the present invention provides a method for increasing the confidence of such a prediction.

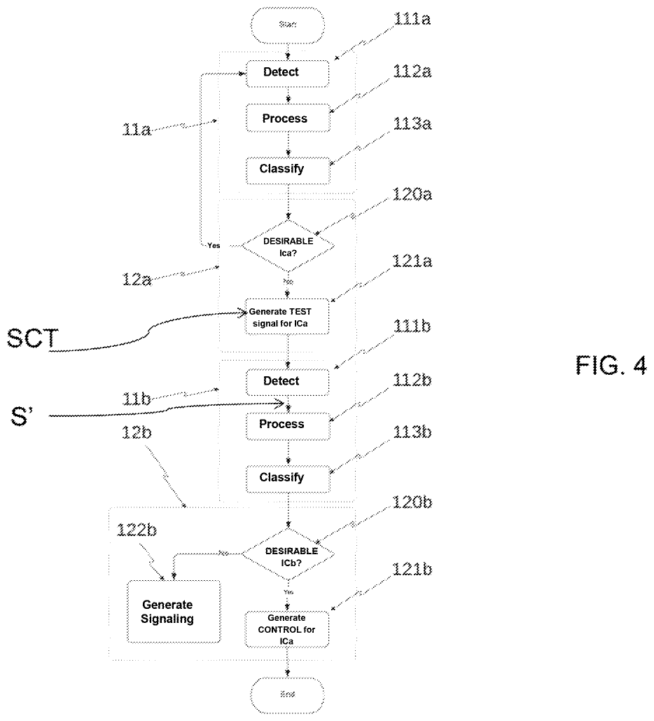

With reference to the embodiment in FIG. 4, the above-mentioned generating step comprises a step 121a of generating a test control signal SCT of the locomotion member 201 or of the grass cutting member 202 when a respective class identification ICa takes the second value indicating an undesirable activity. The purpose of such a test signal SCT is to cancel the at least presumed cause of vibrations indicating undesirable activity classified ICa.

Steps 111a, 112a, 113a and 120a correspond to steps 111, 112, 113, 120 of the method in FIG. 1, respectively. Moreover, the method comprises the steps of:
detecting 111b a further mechanical vibration through the aforesaid one or more vibration sensors 203 to generate a further electrical signal S′ representative of the further mechanical vibration;
processing 112a, by means of the electronic processing unit 204, the further generated electrical signal S′ to extract at least one feature of said signal S′ to generate a further vibrometric mark;
classifying 113b the further generated vibrometric mark to obtain a further class identifier ICb associated with the further vibrometric mark.
   The method further comprises the following alternative steps:
when the further class identifier ICb takes the first value indicating a desirable activity, it means the test was successful and therefore signal SCT actually cancelled the vibrations causing the class identification ICa and the confidence concerning the prediction ICa is quite high. In this case, in step 121b, a further control signal of the locomotion member 201 or of the grass cutting member 202 is generated; according to a preferred embodiment, such a further control signal is specific for the ICa, which was confirmed downstream of the test;
when the further class identifier ICb takes the second value indicating an undesirable activity performed by the robotic lawnmower 10, a signal 122b is generated. In this case, despite the expectation being for the test signal SCT to cancel the cause of the vibrations classified ICa, such vibrations remained also downstream of such a test signal SCT and were detected with the class identification ICb. Therefore, the diagnosis of ICa was not performed correctly.

In other words, with reference to the flow chart in FIG. 4, rather than immediately sending the corrective action 121 as in the general embodiment of method 100 in FIG. 1, two sequential predictions 11a and 11b are performed.

After the first prediction 11a, a test command 121a is sent in order to actually check that the presumptive cause of undesirable activity predicted by 11a was actually resolved.
If, for example step 11a predicts the movement over a non-grassy surface, the test command 121a could be “discontinue motion”. If instead for example, step 11a predicts the blades in contact with non-grassy rigid bodies, the test command 121a could be “stop blades”.

A second prediction 11b is performed upon the performance of the test command. This successive prediction 11b aims at checking the correctness of the first prediction 11a. If the predicted activity resumes being safe, then the first prediction 11a was exact and the corrective commands 121b relating to such a first prediction may be executed.

It should be noted that the corrective commands 121b are added to the test commands 121a and generally differ therefrom. Indeed, while the test commands only serve to discontinue the presumed anomalous source of vibrations according to what is predicted by 11a, the corrective commands are generally more complex sequences of instructions which bring the robotic lawnmower 10 back to a desirable working condition.

This method in FIG. 4 may be integrated with the method in FIG. 3 for a more complete operation, i.e. both test and corrective instructions which are specific to class ICa of undesirable activity may be sent. If, for example, it is predicted in step 11a that blade 202 is in contact with non-grassy rigid bodies, the test command could be “stop blades”; if the activity predicted with 11b downstream of the aforesaid test command is now safe, then corrective instructions are sent which provide, for example moving away from the current working area while keeping the blades stationary, to then turn them back ON when the lawnmower has adequately moved away.

If prediction 11b is an unsafe activity despite the execution of the test command, it means that the first prediction 11a was not correct. Therefore, managing such an inconsistency between the two predictions becomes necessary.

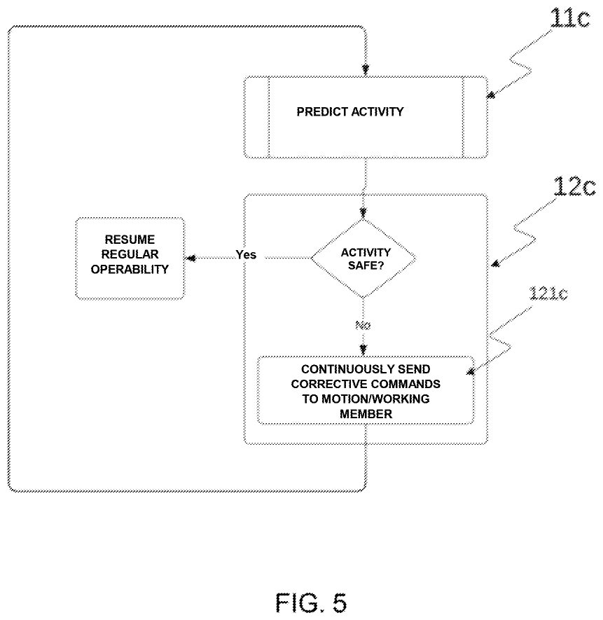

With reference to the embodiment in FIG. 5, when the class identification IC takes the second value indicating an undesirable activity performed by the robotic lawnmower 10, after the step of generating a control signal SC of the locomotion member 201 or of the grass cutting member 202, the method further comprises a step of sequentially repeating, step 11c, the steps of:

detecting 111 at least one mechanical vibration to generate at least one electrical signal S representative of the at least one mechanical vibration;

processing 112 said at least one electrical signal S generated to extract at least one feature of such a signal S to generate a vibrometric mark of the signal;

classifying 113 the generated vibrometric mark to obtain a class identifier IC associated with the vibrometric mark;

generating 121c at least one control signal SC of the locomotion member 201 or of the grass cutting member 202 when said class identifier IC takes the second value.

Such steps are repeated until the class identifier IC again takes the first value indicating a desirable activity performed by the robotic lawnmower 10.

In other words, at least a third activity prediction 11c is executed during the performance of the corrective action to check the correct performance thereof. During the corrective action 121c, the vibrations are constantly monitored and the start of a desirable or safe activity is the end condition of the corrective action.

The method in FIG. 5 may be integrated with the method in FIG. 4 for a more complete operation, i.e. corrective actions which are specific to class ICa of the above-mentioned undesirable activity may continue.

If, for example the prediction is of an activity over a non-grassy surface, the corrective action could be to move with the blades stationary until a grassy area is reached. The predicted activity is in any case unsafe during the movement, until the robotic lawnmower 10 returns to a grassy area, therefore stopping the sending of the corrective commands.

Another example could concern the cutting height: if it is classified that lawnmower 10 is cutting the grass too short, the corrective commands could consist in progressively increasing the distance of the blades from the grass, i.e. moving them away in an orthogonal direction to the ground, so that the portion of cut grass is smaller. The blades are moved away as long as undesired activity is detected.

Vice versa, if the robotic lawnmower 10 detects that the blades are not in contact with the grass (even though they are over a grassy surface), then the corrective command provides reducing the distance of the blades from the grass, i.e. lowering them in an orthogonal direction to the ground, until they come into contact with the grass blades, thus generating the desired vibration which is detected, processed, and classified as such.

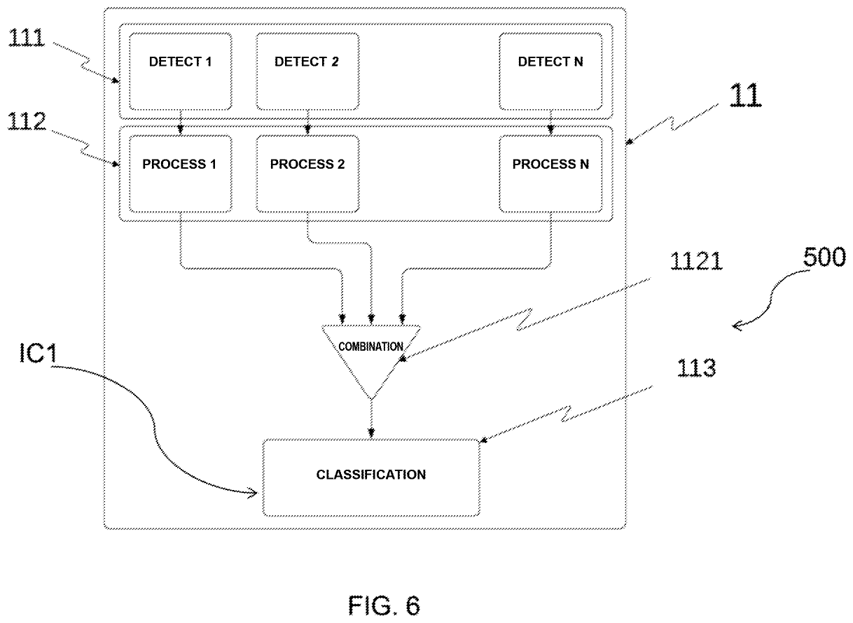

With reference to the embodiment in FIG. 6, method 500 of the invention allows several signals S1, S2, . . . , SN from various vibration sensors 203 to be effectively used by combining respective vibrometric marks and the respective classification.

The sensors 203 may measure vibrations of different means, i.e. they may be microphones and/or accelerometers and/or gyroscopes. Moreover, the sensors 203 may be located in various points of the body of the robotic lawnmower 10.

Additionally, the sensors 203 may be identical to one another and multiplied in order to ensure redundancy and sturdiness for the breakdowns, or they may be oriented in a different manner from one another. In the case of microphones or microphone arrays, they may be oriented in specific directions, also by means of Beamforming techniques known to those skilled in the art.

The various sensors 203 may have sensitivity in various frequency bands.

The vibration sensors 203 jointly capture the vibrations of the robotic lawnmower 10. Each vibration is detected 111 and digitalized according to the above description. Each digital signal S1, S2, . . . , SN is processed 112 to extract one or more features of the signal, obtaining the vibrometric mark of each of them according to techniques already described in general terms for the case described with reference to FIG. 1. Such vibrometric marks are joined or combined with one another in a successive combining step 1121.

In particular, if each vibrometric mark is a number (for example, the energy of the signal), the combination of the vibrometric marks is an array (for example, an energy array).

If each vibrometric mark is an array (for example, the energy in given bands), then the combination is an array or a matrix (which expresses the energy in each band of each sensor).
If each vibrometric mark is a spectrogram (time-frequency-intensity 3D matrix) in a given time interval, the combination of the spectrograms is a 4D spectrogram obtained by overlapping the 3D spectrograms, i.e. a spectrogram configured to highlight time-frequency-intensity-ID sensor for each sensor 203.

With reference to FIG. 6, method 500 of the invention comprises the steps of:

detecting 111, by each sensor 203 of the plurality of vibration sensors, a mechanical vibration VIB1, VIB2, . . . , VIBn to generate a plurality of electrical signals S1, S2, . . . , Sn representative of such mechanical vibrations;

processing 112, by means of the electronic processing unit 204, said plurality of electrical signals S1, S2, . . . , Sn generated to extract at least one feature of the signals to generate a plurality of vibrometric marks, each corresponding to one of such signals;
performing a combining operation 1121 of the plurality of vibrometric marks to generate a first vibrometric mark representative of the combination of the vibrometric marks of the plurality;

classifying 113 the first vibrometric mark to obtain a respective class identifier IC1 associated with the first vibrometric mark, said class identifier being capable of taking a first value indicating a desirable activity performed by the robotic lawnmower 10 or at least a second value indicating an undesirable activity;

generating 121 at least one control signal SC of the locomotion member 201 or of the grass cutting member 202 when said class identifier IC1 takes the second value indicating undesirable activity, to bring the robotic lawnmower 10 back to a condition of desirable activity.

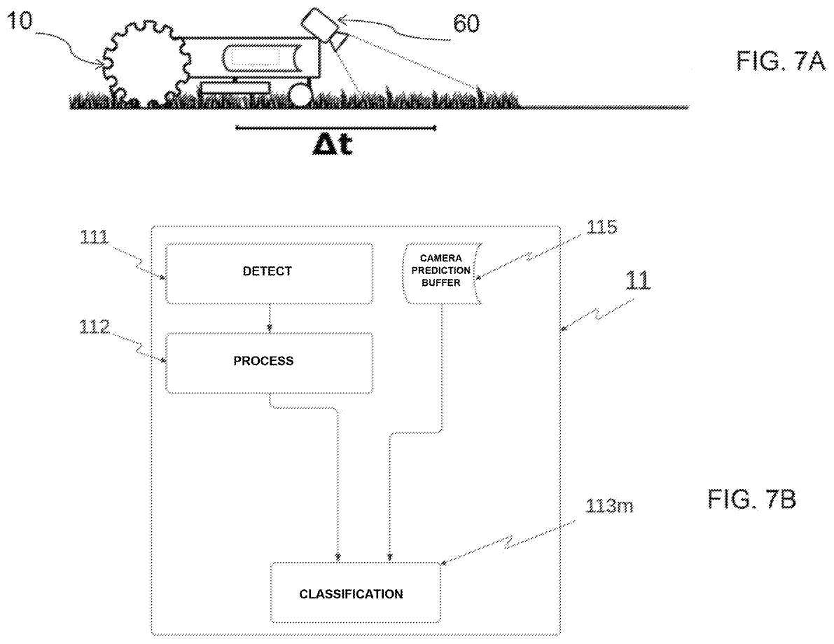

According to a further variant of method 100, with reference to FIGS. 7A-7B, the robotic lawnmower 10 comprises digital image acquisition means 60, for example one or more cameras.

In particular, such one or more cameras 60 may be configured to acquire digital images of a portion of ground in front of the robotic lawnmower 10 and the lawnmower itself is equipped with a machine-vision algorithm of the known type for recognizing possible obstacles or areas which cannot be crossed.

In a different embodiment, such cameras 60 are configured to take pictures of the entire environment in which the robotic lawnmower 10 moves, i.e. they can be oriented in various directions and are not necessarily focused on the ground in front of the lawnmower 10.

FIG. 7a depicts the camera 60 oriented towards the ground in front of the robotic lawnmower 10, however further system variants provide for the camera to be oriented in any other direction, without affecting the ability of lawnmower 10 to visually anticipate the imminent start of an undesirable activity. For example, camera 60 could face upwards and lawnmower 10 could recognize it has arrived close to an area with roots by recognizing the foliage of the overhead trees. A further variant provides for lawnmower 10 to recognize reaching a given location characterized by undesirable activity by the visual triangulation of known reference objects which are visible in the surrounding environment.

For the purposes of the present disclosure, it should be noted that a visual prediction of an undesirable activity made by the robotic lawnmower 10 may be performed, before it happens, by means of machine-vision techniques.

For example, the end of the turf may be visually predicted prior to lawnmower 10 leaving it, as shown in FIG. 7A. Or, it is possible to perform a visual prediction that the robotic lawnmower 10 is entering an impassable area with hidden roots by visually recognizing the specific location of the lawnmower in the working environment.

In particular, with reference to the diagram in FIG. 7B, method 100 of the invention comprises the steps of:

acquiring one or more digital images of a portion of the working environment in which the robotic lawnmower 10 is movable, which is located at a preset distance d from the robotic lawnmower;

generating, at a first time instant t1, on the basis of said one or more acquired digital images, a further identifier representative of a visual prediction of a desirable or undesirable activity performed by the robotic lawnmower 10 at a second time instant t2 subsequent to the first time instant, where t2=t1+Δt;

storing said further identifier in a further memory 115 of the robotic lawnmower 10.

In such a second time instant t2, the classification step comprises a step of classifying 113m both the vibrometric mark generated by at least one mechanical vibration detected through the aforesaid one or more vibration sensors 203 in the second time instant t2 and the further identifier generated in the first time instant t1.

Unlike the vibrometric prediction, which predicts the activity class once the robotic lawnmower 10 is performing it, vision-based prediction allows the prediction of a time interval to be further anticipated, the time interval Δt being given by distance d of the lawnmower from the expected undesirable or unsafe activity start point divided by the advancement speed v of the lawnmower according to the following formula: Δt=d/v. In other words, a given prediction made visually occurs in vibrometric manner after a time interval Δt. FIG. 7A shows an example of interval for a camera 60 focused on the ground, however the same considerations may also be applied to a camera facing any other direction and with any range of visual field.

The solution suggested allows to store temporarily the predictions obtained from the vision system in a further memory 115 or buffer to then extract them after a time interval Δt and perform. certain operations which are useful to particular embodiments of the present invention.

In the embodiment shown in FIG. 7B, the predictions made through the digital image acquisition means and stored in buffer 115 are classified together with the vibrometric marks, thus strengthening the classification capability of the overall system 1000.

If, for example the classification step 113 employs a classifier consisting of a decision tree 113DT, as shown in FIG. 11, as is detailed below, using visual prediction for a given branch could be preferable so as to discriminate circumstances which may be similar to one another in terms of the detection of the vibrations, but very dissimilar from one another in terms of the visual detection with cameras 60.

The data originating from the visual classifier could be discordant from the data verified by means of vibration. In such a circumstance, it is therefore advantageous to save such discordant data in a database, which may then be used to retrain the visual classifier.

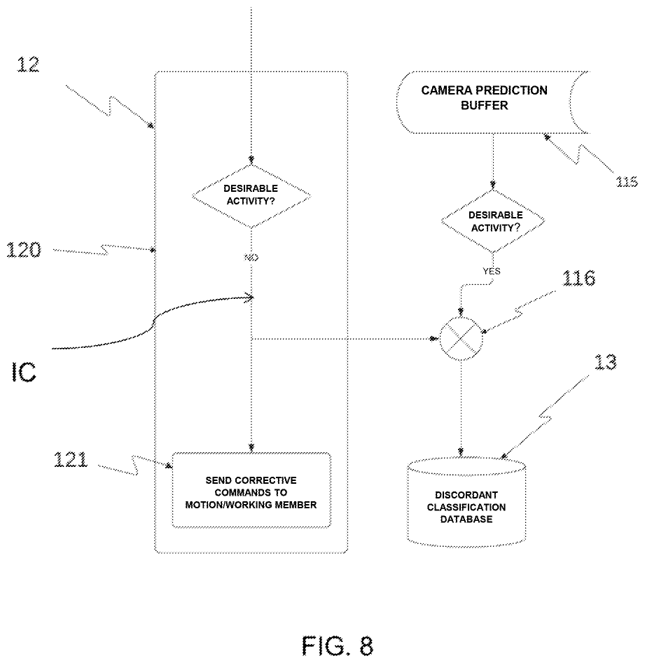

In reference to the flow chart in FIG. 8, in a further embodiment, the method of the invention comprises, in addition to the steps described with reference to FIG. 7B, the steps of:
comparing the class identifier IC associated with the vibrometric mark generated in the second time instant t2 with the aforesaid further identifier representative of a visual prediction of a desirable or undesirable activity associated with said first time instant t1;
modifying the identifier representative of the visual prediction following the detection that the class identifier IC takes the second value indicating an undesirable activity performed by the robotic lawnmower 10 and the further identifier takes a value indicating a desirable activity;
storing such a detection of the discordant classification in a database 13.

In other words, the predictions of the vision system stored in a buffer 115 are compared with the activity obtained by the vibrometric system. If the vision system predicted a desirable activity, where the vibrometric method 11 instead detected an undesirable activity, then the correct classification of the image is stored in a database 13.

It should be noted that the mutual discrepancies may also be stored, i.e. those in which the vision system predicted an undesirable activity while the vibrometric system detected it to be desirable. However for this to occur, the system may be programmed to venture into areas that the vision system deems to be characterized by undesirable activity, to then possibly detect that this is not the case.

It should also be noted that also this further variant is applied irrespective of the specific orientation of camera 60.

Database 13 contains the images the vision system deemed to be anticipatory of desirable activities and which instead resulted being predictive of undesirable places. The availability of database 13 is a necessary condition for locally or remotely retaining the vision system and allowing it to anticipate undesirable activities.

### EXAMPLES

With reference to FIGS. 10A-10H, they describe examples of activities performed by the robotic lawnmower 10 and the corrective actions performed employing the control method 100 of the invention following the discrimination that the aforesaid activities were undesirable.

The activity depicted in FIG. 10A is a desirable activity because lawnmower 10 advances on turf and the grass cutting member 202, i.e. the blade, is in contact with an adequate portion of grass blades. Therefore, according to method 100, the activity is constantly monitored through the vibration sensors 203 but no corrective action is undertaken.

If an undesirable activity were detected, for example one among those shown in FIGS. 10B, 10C, 10D, 10E, 10F, 10G, 10H, a test signal SCT is sent, step 121a, and a corrective signal SC is sent, step 121b.

For example, activity 10B is undesirable because the robotic lawnmower 10 abandoned the grassy surface and is proceeding on a non-grassy surface. The vibrations are generated by the front wheel 10′ of lawnmower 10 which bounces back shaking, and by the cogged rear wheel 10″. The vibrations generated are mechanically propagated through the body of the robotic lawnmower 10 and acoustically in the aerial means. Classification 11 between motion on grassy or non-grassy surface may be obtained by means of one unidirectional accelerometer 203 alone which detects vibrations in the band between 0 Hz and 100 Hz. Such an accelerometer 203 is located close to the front wheel 10′ and oriented along the vertical axis of the lawnmower. Signal S is acquired 111 with sampling frequency of 200 Hz. According to a simplified embodiment, the processing step 112 provides calculating the energy of signal S on 256 consecutive samples of the signal, i.e. for 1.28 seconds, in the band of frequencies between 10 and 14 Hz. It should be noted that a regular robotic lawnmower 10 advances by about 40 cm in 1.28 seconds.

Such energy of signal S in band is compared in the classification step with a threshold set at 5000. If the energy of signal S is less than such a threshold, then it is classified as activity of motion on turf, otherwise it is motion on a non-grassy surface.

Once the specific undesirable activity of motion on a non-grassy surface is recognized by step 11 (see FIG. 1), the most adequate control signal is selected 1211 according to FIG. 3. Specifically, by implementing the method in FIG. 4, first a specific test signal SCT is sent 121a for the specific recognized activity, i.e. the turf being left. In particular, the test signal SCT could consist of stopping the motion of the robotic lawnmower 10. When lawnmower 10 is stationary, the activity is classified as desirable, thus confirming that the cause of the vibrations was precisely the motion of the lawnmower on a non-grassy surface.

Once the classification is confirmed, a specific sequence of corrective actions with at least one control signal SC is selected 121b. Such a sequence of corrective actions leads to an inversion of the motion direction of the robotic lawnmower 10 to return to the grassy area. Such an inversion may be made by a single reverse instruction or alternately by means of sequential instructions, for example a rotation of 180 degrees and a forward drive step.
In both cases, as long as lawnmower 10 is moved to return to a grassy surface, the activity is constantly classified as undesirable. Therefore, the method in FIG. 5 is implemented, which causes the continuation of the forward (or reverse) speed so long as the activity is classified as undesirable motion off the turf. The condition for leaving step 12c is the recognition of the desirable activity, i.e. of motion on grass.

The activity in FIG. 10C is undesirable because the blades 202 of the robotic lawnmower 10 are in contact with an object. The blades are subject to periodic encounters with the projection itself, in particular at the rotation frequency of the blades themselves, thus generating periodic increases in energy, substantially in all the frequency bands. In this case, it is suitable, downstream of the first classification ICa, to employ a signal for discontinuing the motion of the blades 202 as test signal SCT or first corrective control signal.

This action may be accompanied by a stop of the motion and by reversing so as to move the blades away from the presumed undesired object.
If the anomalous vibration disappeared downstream of the test signal SCT, it means the blades are actually in contact with an undesired object. Sequences of corrective actions may lead to the robotic lawnmower 10 moving away, in any direction, in terms of the point characterized by undesirable activity and the blades then being reactivated.

The activity shown in FIG. 10D is undesirable because the box-like body of the robotic lawnmower 10 is in contact with hanging branches. This occurs if there is a grassy surface below the hanging foliage or a hanging item. Common robotic lawnmowers 10 conventionally rotate to change direction when they reach the end of their travel, which is detected by a contact sensor. For example, performing this rotation operation in a bush may result in the robotic lawnmower 10 getting stuck in the bush itself: the branches would hold the box-like body of the robotic lawnmower 10 and the wheels could begin spin idly, thus preventing the motion of the lawnmower and damaging the ground. Here, it is suitable to detect the contact or rubbing condition with the bushes to avoid rotation maneuvers as long as the robotic lawnmower 10 advances or enters the same. When the robotic lawnmower 10 is completely in the bush and such an activity was correctly classified 113, rather than rotating, according to the method of the invention a corrective instruction to reverse is sent which, according to the method in FIG. 5, lasts as long as the branches rub against the box-like body of the lawnmower. The rotary maneuver may be performed when the lawnmower is finally free.

The activity shown in FIG. 10E is undesirable because blade 202 of the robotic lawnmower 10 is in contact with grass which is too thick with respect to the height of the blade itself. Variants of this condition may relate to very wet grass which becomes “mushy” if cut. Cutting dry grass generates “crackling” sounds while cutting wet grass generates a continuous vibration at lower frequencies. Such a difference may be identified by also analyzing the highest frequency bands of signal S, up to 20 KHz. In this case, a microphone 203 located in the lower part of the robotic lawnmower 10, close to blade 202 and therefore protected from external noises, is capable of picking up the useful frequency bands for discriminating such different cutting conditions.

The detection of these conditions is performed in the solutions known to date through the employment of a rain sensor located on the top of the robotic lawnmower. The present invention offers an advantageous method with respect to the employment of the rain sensor. Indeed, the assessment of the grass moisture performed by the robotic lawnmower 10 of the present invention may be useful for cutting only the areas where the grass is already dry, avoiding those where the grass is still wet, or vice versa.

The activity in FIG. 10F is undesirable because blade 202 of the robotic lawnmower 10 is not in contact with grass because it is too high and therefore the lawnmower idly moves. A sequence of corrective actions may relate to the cancellation of the entire cutting operation or the variation of the distance of the blade from the ground.

The activity shown in FIG. 10G is undesirable because the robotic lawnmower 10 has undergone a sudden impact against a hard object which caused a sudden vibration or “shock” to the lawnmower structure. Such a shock is initially detected as energy in all the frequency bands, energy which is quickly zeroed and remains longer only at the resonance frequency of the lawnmower structure.

The activity shown in FIG. 10h is undesirable because voices or noises of living creatures are emitted in the immediate vicinity of the robotic lawnmower 10: such vibrations are mainly propagated acoustically and a directional microphone 203 oriented in the moving direction of the lawnmower is configured to detect them. This allows to avoid moving towards living creatures. In the event an animal were to yelp or a human were to yell or cry, the robotic lawnmower 10 is configured to correctly classify such a sound and undertake the corrective action to completely stop the activity. The recognition of human voices may be effectively performed by means of a trained neural network, for example a convolutional neural network, applied to the spectrogram of microphone 203, for example an MFC spectrogram, i.e. in “MEL Scale” of the type known to those skilled in the art.

Classification Methods

Certain embodiments of the classification method 113 in FIG. 1 and the related steps 112 for processing signal S which are preparatory to the classification itself, are described below.

As already mentioned, the energy in a given band of signal S may be employed to discriminate a pair of activities. However, when the number of activities is greater than two, the employment of a single discriminating threshold is not sufficient.

In this case, with reference to FIG. 11, a specific implementation of the classification step 113 comprises the employment of decision trees 113DT, i.e. an ordered sequence of discriminating thresholds.

Again with reference to FIG. 11, step 113DT receives in input the value of the energy of signal S, calculated in reduced time windows, in various frequency bands 113DTi. Such energy was extracted from signal S in the preceding processing step 112. The decision tree compares a level of energy with a threshold. In the specific tree in FIG. 11, between 2 and 4 comparisons are made according to the branch, to arrive at the conclusion of the activity class.

Such decision trees are “very light” from a computational viewpoint and may be directly implemented on certain sensors (e.g.: LSM6DSOX di ST Microelectronics) already provided with adequate storage and computational unit resources, i.e. they have a directly integrated processing unit 204. In the specific example in FIG. 11, energy values are extracted from 6 frequency bands of a signal detected with a unidirectional accelerometer located close to the front wheel 10′ of the robotic lawnmower 10 and oriented along the vertical axis of the lawnmower itself.

According to FIG. 6, energy levels in specific frequency bands of signals acquired by several sensors may be used. For example, accelerometers on the market commonly have 3 axes and it is particularly advantageous to process the energy, in particular longitudinal, transversal, and vertical bands to allow the decision tree 113DT to best discriminate the various classes. Similarly, energy levels for frequency bands obtained from gyroscopes or microphones may be processed.

As already shown, the decision tree 113DT may receive in input other values to be used as discriminating threshold in one or more branches, for example it may receive in input a prediction made by means of vision means.

The decision trees may be inserted by the user him/herself or may be learned by the robotic lawnmower 10.

The classifier may be trained with a machine-learning technique, not necessarily a decision tree, on the basis of a plurality of sensorial experiences collected. Once all the sensors are placed on the robotic lawnmower 10 in the desired position and orientation, the lawnmower, or several clones thereof, is left to operate in a variety of working environments so that the sensory data from accelerometers, gyroscopes and microphones are recorded. In this case, it is suitable for there to be a large number of disturbances in the various environments, for example machines at work or gardeners working with other garden equipment. This allows to collect different data and allows lawnmower 10 to learn only the useful data in the training step. Once a plurality of recordings is collected from the various sensors, they are manually labeled, i.e. a specific activity class is associated.

Various decision trees may be trained through machine-learning techniques. Several decision trees with mutually different branches may be simultaneously used, each achieving an independent intermediate classification. Then an average thereof is used. Such a machine-learning technique, which is known to those skilled in the art, is called Random Forest (Forest of decision trees).

Recent Artificial Intelligence (AI) techniques are based on the use of neural networks, in particular CNNs (Convolutional Neural Networks) and RNNs (Recurrent Neural Networks).

With reference to FIG. 12, the processing step 112 generates a spectrogram 113conv-i, for example by calculating the energy in the bands by means of FFT (Fast Fourier Transform). Such a spectrogram is sent in input to a trained neural network 113conv, for example of known convolutional type. The spectrogram may be of the MFCC type, which is known to those skilled in the art. The advantage of using convolutional neural networks applied to a spectrogram with respect to decision trees is that the convolutional neural networks tend to consider the time evolution of the energy in the various bands by recognizing more complex patterns. The convolutional neural network in FIG. 12 is formed by a series of convolutional levels, Conv1, Conv2, . . . , ConvN, which extract a hierarchy of features. Each convolutional level may also include one or more “RelU” operations, of the type known to those skilled in the art. At the end of the convolutions, there is a “Fully Connected”, FC, layer which returns the predictions of the various activities in the form of more or less intense activation of the output neurons.

The control method 100 and system 1000 of the present invention have other advantages in addition to those mentioned above, with respect to the known solutions.

Firstly, the present invention is more versatile, adaptable, and quicker to employ with respect to the cutting solutions resorting to delimiting the working environment through perimeter cord.

Another advantage is the confining to a desirable area, possibly redounding other sensors intended for the purpose thereof, such as for example, a vision sensor. In particular on a grassy area, thus avoiding accidental breakaways and eliminating the setup step.

The robotic lawnmower 10 provides a quick reaction to objects or living creatures which may accidentally come into contact with the cutting member 202. In particular, it is capable of strongly recognizing this condition better than systems currently on the market.

Moreover, the robotic lawnmower 10 is configured to extricate itself from hanging obstacles, avoiding system 1000 from becoming entangled, therefore remaining trapped and incapable of continuing the cutting task.

The robotic lawnmower 10 ensures a more efficient cut as a function of the conditions of the turf: the system may automatically adapt its speed or cutting height according to the type of turf, or even avoid cutting the grass if it is too wet or already adequately cut to a given height. This allows an improved cutting quality with respect to the known techniques.

Moreover, the solution suggested is more reliable and stronger in discriminating desirable working conditions from an undesirable or unsafe activity because the detection of the vibrations employed by the invention allows to discriminate the working conditions which are desirable but could generate false positives with the conventional methods.

Moreover, it should also be noted that the peculiarities of the method of the present invention can also be applied to other types of yard equipment other than the robotic lawnmower 10, such as for example robotic pressure washers, robotic fertilizers, robotic deck cleaners, robotic snow blowers. These robotic yard apparatuses differ from the above-described robotic lawnmower 10 because they each comprise a respective working member other than the grass cutting member.

Moreover, it should also be noted that robotic lawnmower means machines of any size and level of autonomy. Certain large robotic lawnmowers are often supervised by an on-board or remote operator; the method of the present invention can be applied in all these cases.

Those skilled in the art may make changes and adaptations to the embodiments of the method and system of the invention or can replace elements with others which are functionally equivalent in order to meet contingent needs without departing from the scope of the following claims. Each of the features described as belonging to a possible embodiment can be achieved irrespective of the other embodiments described.

1-16. (canceled)

17. A method for controlling a robotic lawnmower in a working environment, said robotic lawnmower comprising:
a locomotion member;
a grass cutting member;
one or more vibration sensors adapted to detect mechanical vibrations generated in said working environment and which are propagated through a body of the robotic lawnmower or through surrounding air;
the method comprising the steps of:
detecting at least one mechanical vibration through said one or more vibration sensors to generate at least one electrical signal representative of the at least one mechanical vibration;
processing, by an electronic processing unit, said at least one generated electrical signal to extract at least one feature of said signal to generate a vibrometric mark of the signal;
classifying said generated vibrometric mark to obtain a class identifier associated with the vibrometric mark, said class identifier being capable of taking a first value indicating a desirable activity performed by the robotic lawnmower or a second value indicating an undesirable activity;
generating at least one control signal for controlling the locomotion member or the grass cutting member when said class identifier takes said second value to bring the robotic lawnmower back to a condition of desirable activity.

18. The method for controlling a robotic lawnmower according to claim 17, wherein said second value of the class identifier includes a plurality of second values, each indicating an undesirable activity and associated with one of a plurality of control signal sequences, and wherein said step of generating a control signal for the robotic lawnmower comprises the steps of:
selecting a control signal sequence among the control signal sequences of said plurality;
providing the locomotion member or the grass cutting member with said selected control signal sequence to bring the robotic lawnmower back to a condition of desirable activity.

19. The method for controlling a robotic lawnmower according to claim 17, wherein when the class identifier takes the second value indicating an undesirable activity, said generating step comprises a step of generating a test control signal of the locomotion member or of the grass cutting member, the method further comprising:
detecting a further mechanical vibration through said one or more vibration sensors to generate a further electrical signal representative of said further mechanical vibration;
processing, by said electronic processing unit, said further electrical signal to extract at least one feature of said signal to generate a further vibrometric mark;
classifying said further generated vibrometric mark to obtain a further class identifier associated with the further vibrometric mark.

20. The method for controlling a robotic lawnmower according to claim 19, the method further comprising:
generating a further control signal of the locomotion member or of the grass cutting member when said further class identifier takes the first value indicating a desirable activity,
generating a signal when said further class identifier takes said second value indicating an undesirable activity performed by the robotic lawnmower.

21. The method for controlling a robotic lawnmower according to claim 17, wherein when said class identifier takes said second value indicating an undesirable activity, after said step of generating at least one control signal of the locomotion member or of the grass cutting member, the method comprises a step of sequentially repeating the steps of:
detecting at least one mechanical vibration to generate at least one electrical signal representative of the at least one mechanical vibration;
processing said at least one electrical signal generated to extract at least one feature of said signal to generate a vibrometric mark of the signal;
classifying said generated vibrometric mark to obtain a class identifier associated with the vibrometric mark,
generating at least one control signal of the locomotion member or of the grass cutting member when said class identifier takes said second value, up to when said class identifier takes said first value indicating a desirable activity performed by the robotic lawnmower.

22. A method for controlling a robotic lawnmower in a working environment, said robotic lawnmower comprising:
a locomotion member;
a grass cutting member;
a plurality of vibration sensors, each of the vibration sensors being adapted to detect a mechanical vibration generated in said working environment and which is propagated through a body of the robotic lawnmower or through the surrounding air;
the method comprising the steps of:
detecting, by each sensor of the plurality, a mechanical vibration to generate a plurality of electrical signals representative of said mechanical vibrations;
processing, by an electronic processing unit, said plurality of electrical signals generated to extract at least one feature of said signals to generate a plurality of vibrometric marks, each of the plurality of vibrometric marks corresponding to one of said signals;
performing a combining operation of the plurality of vibrometric marks to generate a first vibrometric mark representative of the combination of the vibrometric marks of the plurality;
classifying said first generated vibrometric mark to obtain a class identifier associated with the first vibrometric mark, said class identifier being capable of taking a first value indicating a desirable activity performed by the robotic lawnmower or a second value indicating an undesirable activity;
generating at least one control signal of the locomotion member or of the grass cutting member when said class identifier takes said second value to bring the robotic lawnmower back to a condition of desirable activity.

23. The method for controlling a robotic lawnmower according to claim 17, wherein the robotic lawnmower includes one or more cameras to acquire digital images, said method further comprising the steps of:
acquiring one or more digital images of a portion of the working environment in which the robotic lawnmower is movable, which is located at a preset distance from the robotic lawnmower;
generating, at a first time instant, based on said one or more acquired digital images, a further identifier representative of a visual prediction of a desirable or undesirable activity performed by the robotic lawnmower at a second time instant t2 subsequent to the first time instant t1, where t2=t1+Δt;
storing said further identification in a further memory of the robotic lawnmower, and wherein, in said second time instant, said classification step comprises a step of classifying both the vibrometric mark generated by a mechanical vibration detected through said one or more vibration sensors in said second time instant and said further identifier generated in said first time instant.

24. The method for controlling a robotic lawnmower according to claim 17, wherein the robotic lawnmower includes one or more cameras to acquire digital images, said method further comprising the steps of:
acquiring one or more digital images of a portion of the working environment in which the robotic lawnmower is movable, which is located at a preset distance from the robotic lawnmower;
generating, at a first time instant, on the basis of said one or more acquired digital images, a further identifier representative of a visual prediction of a desirable or undesirable activity performed by the robotic lawnmower at a second time instant t2 subsequent to the first time instant t1, where t2=t1+Δt;
comparing said class identifier associated with the vibrometric mark generated in said second time instant with said further identifier representative of a visual prediction of a desirable or undesirable activity associated with said first time instant;
modifying the identifier representative of the visual prediction when the class identifier takes the second value indicating an undesirable activity performed by the robotic lawnmower and the further identifier takes a value indicating a desirable activity;
storing said detection of the discordant classification in a database.

25. The method for controlling a robotic lawnmower according to claim 17, wherein said vibration sensors are selected from the group consisting of: microphones, accelerometers, gyroscopes.

26. The method for controlling a robotic lawnmower according to claim 17, wherein when said second value of undesirable activity is an activity of leaving the turf, the at least one control signal is a command to the locomotion member for stopping motion in a current direction or for inverting a motion direction.

27. The method for controlling a robotic lawnmower according to claim 17, wherein when said second value of undesirable activity is an activity of rubbing against a bush, the at least one control signal is a command to the locomotion member for inverting a motion direction.

28. The method for controlling a robotic lawnmower according to claim 17, wherein said vibrometric mark extracted from the signal is a band frequency energy of the detected signal and said classification step comprises a step of employing at least one decision tree.

29. The method for controlling a robotic lawnmower according to claim 17, wherein said vibrometric mark extracted from the signal is a spectrogram of the detected signal and said classification step comprises at least forward feeding of a trained neural network.

30. The method for controlling a robotic lawnmower according to claim 17, wherein said classification step comprises:
collecting sensory data from a plurality of vibration sensors in a variety of working environments;
labeling said sensory data by associating a specific activity class to each of the sensory data;
applying machine-learning techniques for training a classifier;
using said classifier in said classification step.

31. A system comprising:
a robotic lawnmower including a locomotion member for moving the robotic lawnmower in a working environment;
a grass cutting member;
one or more vibration sensors adapted to detect mechanical vibrations generated in said working environment and which are propagated through a body of the robotic lawnmower or through surrounding air;
an electronic processing unit connected to said one or more vibration sensors and to said locomotion member and grass cutting member;
wherein said electronic processing unit comprises at least one processor and a memory block associated with the processor to store instructions, said processor and said memory block being configured to perform the steps of the method according to claim 17.

32. The system according to claim 31, wherein said processing unit comprises an input/output interface connected to the at least one processor and to the memory block to allow an operator close to the system to directly interact with the processing unit.

33. The system according to claim 31, further comprising one or more cameras to acquire digital images.
